(19) United States
(12) Patent Application Publication
(10) Pub. No.: US 2011/0079616 A1
(43) Pub. Date: Apr. 7, 2011

(54) Apparatus And Method Of Dispensing An Attractant Or Scent Blocker

(76) Inventor: Charles R. Holmes, Roxie, MS (US)

(21) Appl. No.: 12/825,808

(22) Filed: Jun. 29, 2010

Related U.S. Application Data
(60) Provisional application No. 61/248,587, filed on Oct. 5, 2009.

(51) Int. Cl. B67D 7/76; B65D 83/00

(52) U.S. Cl. 222/189.1; 222/401

(57) ABSTRACT

A device including a container which defines a primary opening and a container outlet, a pressurizing member attached to or integral with the container and configured pressurizing the contents of the container, a liquid conduit defining a conduit inlet and a conduit outlet, the conduit inlet being in fluid communication with the interior of the container, a spray nozzle attached to or integral with the conduit and in fluid communication therewith, a valve for controlling the flow of liquid from the container to the spray nozzle, and a filter disposed upstream of the spray nozzle. A related method is also described.

### REFERENCE TO RELATED APPLICATION

Claim is hereby made to the benefit of the priority of the filing date of U.S. Provisional Patent Appl. No. 61/248,587, filed on Oct. 5, 2009, the disclosure of which is incorporated herein by reference.

### FIELD OF THE INVENTION

This invention pertains to systems and methods of dispensing attractant scents and/or scent blockers, especially those which are useful when tracking or hunting wildlife.

### THE INVENTION

The present device features a pump action system pressurizing a bottle or other container equipped with a micro-misting or atomizing spray nozzle and attached hose or the like, to distribute an attractant or scent eliminator into the air by way of the micro-atomizing tip or nozzle, blocking human scent from, or attracting as the case may be, approaching deer or other animals such as hogs, coyotes, bears, elk, wolves, bobcats, lynx, mountain lions, or other game. Thus, in one embodiment, the invention provides a device comprising

a container which defines a primary opening and a container outlet,

a pressurizing member attached to or integral with the container and configured for pressurizing the contents of the container,

a liquid conduit defining a conduit inlet and a conduit outlet, the conduit inlet being in fluid communication with the interior of the container,

a spray nozzle attached to or integral with the conduit and in fluid communication therewith,

a valve for controlling a flow of liquid from the container to the spray nozzle, and

a filter disposed upstream of the spray nozzle.

In another embodiment, the invention provides a method for dispensing a liquid scent blocker or liquid animal attractant, the method comprising

placing the liquid into the above-referenced container,

pressurizing the liquid in the container by actuating the pressurizing member while the valve is in a closed position,

placing the valve in an open position, and

disposing the nozzle in a position to direct liquid ejected from the nozzle in a desired direction.

Still another embodiment of the invention is a method for dispensing a liquid scent blocker or liquid animal attractant, wherein the method comprises

placing the liquid into a manually portable container, which container is in fluid communication with a conduit inlet of a liquid conduit, the liquid conduit comprising a spray nozzle in fluid communication with the conduit and a valve for controlling dispensation rate through the nozzle;

pressurizing the liquid in the container by actuating a pressurizing member attached to or integral with the container while the valve is in a closed position,

placing the valve in an open position while the liquid in the container is pressurized, and

disposing the nozzle in a position to direct liquid ejected from the nozzle in one or more desired directions.

These and other aspects, features and advantages of the present invention shall become further apparent from the ensuing detailed description, figure and appended claims.

### SUMMARY OF THE FIGURE

FIG. 1 is a cross-sectional side view of a device according to one embodiment of this invention.

### DETAILED DESCRIPTION

As used herein “scent” refers to any fluid which is designed to either attract other wildlife or to block the scent of the user to wildlife in the area.

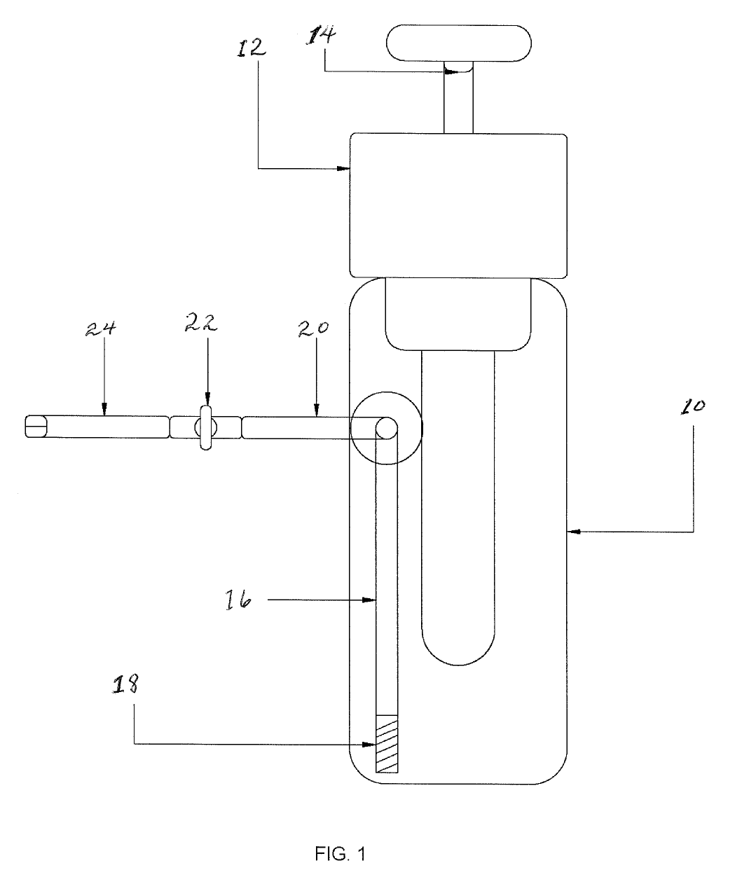

One example of one embodiment of the invention is illustrated in the attached FIG. 1. The device includes a container 10, pressurizing member in the form of a pressure pump 12 threaded onto the container at a primary opening thereof, in sealing relationship with the container, and equipped with a noise depressor 14, a feed tube 16, a filter 18, a hose 20, a control valve 22 and a spray nozzle 24. When container 10 is filled with a fluid and pressurized using hand pump 12, the fluid enters feed tube 16 through filter 18, and then feeds into hose 20, which is preferably at least 3-4 feet in length. The fluid may then pass through control valve 22 when that valve is in an open position, to then be dispersed into the surrounding atmosphere through micro-spray nozzle 24. The spray so formed creates at least some very small droplets of fluid that tend to float for an extended period of time (seconds to minutes, for examples) in the surrounding air. Dispensing of the fluid can be controlled by closing or opening valve 22, as desired and appropriate. Container 10 is preferably of a portable size, and that portable size should preferably be sufficient to hold enough attractant or scent blocker fluid to permit a user to dispense for no less than about 15 minutes, and up to about 1 hour, at a typical flow rate of about 1 oz. (28.4 ml) per minute through atomizing spray nozzle 24. Typically, this means container 10 will hold in the range of at least about 16 to about 30 ounces of fluid, depending upon the fluid concentration used.

It should be appreciated that the illustrated manual pressurizing member is but one example of suitable a pressurizing member. Other pressurizing devices (such as lever pumps, pneumatic or hydraulic devices or gas expansion-based pressurizers, and the like) may be employed in alternative embodiments of the invention, as long as such devices provide pressure within the container to maintain a flow of liquid out of the container and through the atomizing nozzle when the value is in an open position.

The same distribution system works equally well to attract any of the above noted animals when an attractant is used instead of a scent eliminator. Previously known scent dispersant systems have come up short due to their lack of any ability to dispense enough scent to cover up the human odor, or any ability to spray down the whole human body with scent killer to eliminate the human odor. Prior systems employed small, e.g., 2-4 oz., reservoirs. They also lack the ability to spray scent in a controlled flow for extended periods of time, or at long distances (e.g., 15 feet or more) in order to apply scent at a distance for the purpose of leaving no human scent in the area. Previous systems were too bulky and very easy to break, having excessive connections to permit leakage. The leaks in prior systems will almost always be inside the container were it is almost impossible to fix. The present invention provides substantially all of the connections on the outside of the container/system, and is almost indestructible in certain preferred aspects of the invention. This system enables a user to mount the nozzle down wind and above the user to allow the scent to travel away from the user to block his or her odor while also permitting the user to control the flow out of the system. So far as is known, existing systems do not have these features. Aspects of the present invention enable the user to easily move the nozzle if the wind changes direction, something which is more difficult, if not impossible, in the known bulky units which must be mounted upright on a tree or like structure.

Without being bound to theory, in at least some embodiments of the invention, as a user sprays the scent into the air, the tip is actually emitting small droplets of liquid and larger droplets of liquid. The smaller droplets are carried with the wind great distances and the larger droplets fall to the ground quicker, and are believed to do so while taking the user's scent with them. Thus, it is believed that, not only does the system block out the user's human odor, but the larger droplets of liquid carry the human scent to the ground.

The vapor of the atomizing tip distributes the attractant or scent eliminator into the air in such a manner that utilizes the prevailing winds to carry the vapor throughout the woods or desired area in turkey fanlike fashion causing the width of the span to increase as the mist travels downwind. There are a number of scents that can be used in the unit which include, for example: doe in heat, dominant buck, estrus, raccoon, skunk, buck and doe urine, tarsal gland, elk urine, apple, acorn, persimmon and any other types of cover scent or food sources.

Hunters are not the only consumer that can benefit from the atomized vapor produced by the present device. Photographers, nature enthusiasts, trappers, wildlife officers and biologists can also employ the attractant and scent blocking properties to enhance their sport or line of work.

This invention enables a highly effective distribution of scent in a manner which is highly portable and sturdy. The device of the invention includes a hose (preferably about four feet or greater in length) in fluid communication with the volume defined by the container. The hose further comprises a shut-off valve which permits a trail of scent to be sprayed while walking and/or mist an attractant or scent eliminator in an even distribution over one's body and/or the surrounding environment. The ability to remove and replace the spray tip provides the capability to spray a solid stream of scent into a desired area. For example, a scrape from a distance of at least 20 feet away and then return to the vapor mist with ease.

The atomization process of the scent and, in preferred embodiments of the invention, a filter incorporated into the bottle (proximate to or within the hose intake) can cause the scent to be extremely pronounced. Therefore, one typically may dilute scent (e.g., by adding creek or pond water) to extend the life of the scent. The filter at the hose intake ensures that particulate matter which may be present in the scent solution does not clog the micro-spray tip during dispensation of the contents of the pressurized container. In a particular aspect of the invention, the container preferably includes effective sealing means (e.g., an o-ring, gasket or other mechanical seal) for sealing a removable, lid to the container body after the liquid to be dispensed is placed within the container.

### Other Features and Advantages of the Invention

Other features, uses and advantages of certain embodiments of the invention can include, for example:

(1) Enabling the outdoorsman to spray a substantially constant wall-like barrier of liquid scent between him and the animal for a significant duration (e.g., about 18 minutes or more) to keep the animal from detecting the user's scent.
(2) Enabling the outdoorsman to spray a full scent trail as he walks into the woods and around the woods. The trail will be substantially constant and well defined because of the substantially constant spraying from the nozzle. Also while walking the outdoorsman can spray the scent on the tree limbs to be carried by the prevailing winds down through the woods to bring animals into the area.
(3) Enabling the outdoorsman to put the scent down through the woods in a liquid form to attract the animals to his location. All animals are believed to smell in a liquid form. When the hunter is up in a tree and has the device on it is using the prevailing winds to carry the scent down through the woods in its liquid form. If a user has a 3 mph wind, it will carry the scent up to approximately ⅛ mile or more. Because of the large capacities of the unit you can constantly spray if desired. Because of the on/off valve the user can control the scent in any manner desired.
(4) By removing the micro-spray nozzle, a user has the ability to spray a solid stream of scent approximately 5, 10 or 15 feet out, for example. This could be used to spray scent into a scrape or other place of interest, without having to walk up to it and leaving human scent in the area.
(5) The even misting spray of the unit can provide a superior scent dispenser. Because of the hose a user can spray the back of his or her legs and back. All of this is done with out having to pump a bottle for each bit of scent and missing areas which will emit user scent. The device sprays a solid wall of scent, preventing the user from missing areas to allow scent to form. When using the unit one will use significantly less scent because it will only take about 6 seconds, for example, to spray an entire whole body, leaving no spot uncovered.
(6) The device can enable the hunter to spray all of his clothes and backpack before putting them on or with them on, all without continuous manual pumping action.
(7) The device can be modified with an optional tire chuck that replaces the micro-spray nozzle to enable pump up of vehicle tires if a user has a leak allowing you to get out of the woods. Comes with caring case and belt.
(8) The device can be modified for use with a push button valve that will allow the fisherman to spray his lures down with a fish attractant or scent with the push of a button. He can hold his lure over the edge of the boat for spraying to prevent from getting scent into the carpet of the boat. Because of the small particles of liquid sprayed from the unit, the scent remains in better contact with and distribution on the lure.
(9) At the end of a day of salt water fishing a user can put fresh water into the unit to wash down reels and line, for example. The unit can be configured to control the pressure used so that it does not force the water and grit into the inside parts of the reel. The right amount of pressure enables removal of salt and grime from the reel and rod eyes and the nozzle can be configured to provide a wide amount of spray to accomplish a covering spray in a short amount of time. Such a device might have accessories such as a caring case and belt.
(10) The unit may have a 12 inch hollow tube that attaches between the push button valve and the micro tip. This would allow for extended reach in cabinets or hanging plants. With ½ oz insecticide and 16 ozs. water a user has the perfect sprayer for residence or trailer with out all of the bulk of a garden sprayer. This could allow for use with small quantities to avoid bulk storage. The unit may spray in a smaller amount to avoid liquid splattering off of the walls and baseboards and can be concentrated where desired. Can weigh less than 3 lbs. when fabricated with lightweight plastics or like materials. One can do anything with the unit that you can do with a garden sprayer with out all of the bulk. Such solutions are better than aerosol-based designs is that one can concentrate the liquid where desired and not fog up a house or cabinets.
(11) Can be used to water plants inside. Because of the misting action one can spray with out getting liquid on the surrounding floor. Fertilizers can be included in the liquid to spray plants or garden. One need mix only the quantity needed, without the tiring pumping action of larger manual pump sprayers.
(12) The device also makes a great insect foggier for outdoors. The unit may spray insecticide into the air around the perimeter of an area to keep bugs and mosquitoes away.
(13) The device can make a mister for spraying pleasant scents into a home or other area.
(14) The unit can be configured to provide an eye wash, to remove foreign bodies or chemicals. It can be useful for workers who handle chemicals where there is no eye wash available, such as pumping stations or forestry workers handling chemicals in the woods. Enables one to flush the eyes for over 15 minutes without stopping and without assistance from others. You can flush or wash out eyes while alone and it is small enough to store anywhere or wear around the waist with a caring case and belt.

Of course, not all embodiments of the invention will necessarily provide all or even many of the foregoing advantages and features, but the multi-purpose nature and capabilities of the present invention is readily apparent from the foregoing.

While this invention is described with reference to a particular illustration of one embodiment of the invention, the invention is not limited thereto, as the invention is susceptible to wide variation within the spirit and scope of the following claims.

That which is claimed is:

1. A device comprising
a container which defines a primary opening and a container outlet,
a pressurizing member attached to or integral with the container and configured for pressurizing the contents of the container,
a liquid conduit defining a conduit inlet and a conduit outlet, the conduit inlet being in fluid communication with the interior of the container,
a spray nozzle attached to or integral with the conduit and in fluid communication therewith,
a valve for controlling a flow of liquid from the container to the spray nozzle, and
a filter disposed upstream of the spray nozzle.

2. The device of claim 1, wherein the spray nozzle is a micro-misting spray nozzle.

3. The device of claim 2, wherein the pressurizing member comprises a sealing lid configured to attach to the container at the primary opening of the container, and a manual pressure pump attached to or integral with the sealing lid.

4. The device of claim 3, wherein the liquid conduit comprises an inlet end portion which is in substantially sealing relationship with the container at the container outlet.

5. The device of claim 4, wherein the filter is removable and is disposed proximate to the conduit inlet so as to filter liquid which enters the conduit inlet from the interior of the container during use.

6. The device of claim 5, wherein the container is sized and configured to hold at least 12 fluid ounces of liquid under ambient pressure and temperature conditions.

7. A method for dispensing a liquid scent blocker or liquid animal attractant, the method comprising
providing a device in accordance with any of the foregoing claims,
placing the liquid into the container,
pressurizing the liquid in the container by actuating the pressurizing member while the valve is in a closed position,
placing the valve in an open position, and
disposing the nozzle in a position to direct liquid ejected from the nozzle in a desired direction.

8. A method for dispensing a liquid scent blocker or liquid animal attractant, the method comprising
placing the liquid into a manually portable container, which container is in fluid communication with a conduit inlet of a liquid conduit, the liquid conduit comprising a spray nozzle in fluid communication with the conduit and a valve for controlling dispensation rate through the nozzle;
pressurizing the liquid in the container by actuating a pressurizing member attached to or integral with the container while the valve is in a closed position,
placing the valve in an open position while the liquid in the container is pressurized, and
disposing the nozzle in a position to direct liquid ejected from the nozzle in one or more desired directions.
